(19) United States
(12) Patent Application Publication
(10) Pub. No.: US 2025/0300860 A1
(43) Pub. Date: Sep. 25, 2025

(54) SYSTEM AND METHOD FOR EXCHANGING SRS CONFIGURATION PARAMETERS BETWEEN AN O-DU AND AN O-RU

(71) Applicant: Samsung Electronics Co., Ltd., Suwon-si (KR)

(72) Inventors: Shruti VENKATESH, Mumbai (IN); Rajeev RANJAN KUMAR, Bangalore (IN); Mahantesh KOTHIWALE, Belgaum (IN); Apoorva C, Karnataka (IN); Shreyansh GUPTA, Surajpur (IN)

(21) Appl. No.: 19/084,162

(22) Filed: Mar. 19, 2025

(30) Foreign Application Priority Data
Mar. 19, 2024 (IN) 202441020494
Mar. 20, 2024 (IN) 202441021157
Jan. 13, 2025 (IN) 2024 41020494
Mar. 18, 2025 (KR) 10-2025-0034972

(51) Int. Cl. H04L 25/02

(52) U.S. Cl. CPC H04L 25/0224; H04L 25/0242

(57) ABSTRACT

The disclosure relates to a 5th generation (5G) communication system or a 6th generation (6G) communication system for supporting higher data rates beyond a 4th generation (4G) communication system, such as long term evolution (LTE). A method performed by an open radio access network (O-RAN) distributed unit (DU) (O-DU) in a wireless communication system is provided. The method includes obtaining a set of sounding reference signal (SRS) configuration parameters from a functional application platform interface (FAPI) SRS PDU message, and transmitting, to an O-RAN radio unit (O-RU), an SRS configuration message including the obtained set of SRS configuration parameters, wherein the SRS configuration message enables the O-RU to perform an SRS-based channel estimation.

### CROSS-REFERENCE TO RELATED APPLICATION(S)

This application is based on and claims priority under 35 U.S.C. § 119 (a) of an Indian Provisional patent application No. 202441020494, filed on Mar. 19, 2024, in the Indian Intellectual Property Office, and of an Indian Provisional patent application No. 202441021157, filed on Mar. 20, 2024, in the Indian Intellectual Property Office, and of an Indian Complete patent application No. 202441020494, filed on Jan. 13, 2025, in the Indian Intellectual Property Office, and of a Korean patent application number 10-2025-0034972, filed on Mar. 18, 2025, in the Korean Intellectual Property Office, the disclosure of each of which is incorporated by reference herein in its entirety.

### BACKGROUND

### 1. Field

The disclosure relates to wireless communication systems. More particularly, the disclosure relates to a method and system for exchanging sounding reference signal (SRS) configuration parameters between an open radio access network (O-RAN) distributed unit (DU) (O-DU) and an O-RAN radio unit (O-RU), in an O-RAN architecture.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies, such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems, a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services, such as truly immersive extended reality (XR), high-fidelity mobile hologram, and digital replica could be provided through 6G communication systems. In addition, services, such as remote surgery for security and reliability enhancement, industrial automation, and emergency response will be provided through the 6G communication system such that the technologies could be applied in various fields, such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and system for exchanging sounding reference signal (SRS) configuration parameters between an open radio access network (O-RAN) distributed unit (DU) (O-DU) and an O-RAN radio unit (O-RU), in an O-RAN architecture.

Additional aspects will be set forth in part in the description which follows and, in part, will be apparent from the description, or may be learned by practice of the presented embodiments.

In accordance with an aspect of the disclosure, a method performed by an open radio access network (O-RAN) distributed unit (DU) (O-DU) in a wireless communication system is provided. The method includes obtaining a set of sounding reference signal (SRS) configuration parameters from a functional application platform interface (FAPI) SRS PDU message, and transmitting, to an O-RAN radio unit (O-RU), an SRS configuration message including the obtained set of SRS configuration parameters, wherein the SRS configuration message enables the O-RU to perform an SRS-based channel estimation.

In accordance with another aspect of the disclosure, an open radio access network (O-RAN) distributed unit (DU) (O-DU) is provided. The O-DU includes at least one processor, configured to obtain a set of SRS configuration parameters from a functional application platform interface (FAPI) SRS PDU message, and transmit, to O-RAN radio unit (O-RU), a sounding reference signal (SRS) configuration message including the obtained set of SRS configuration parameters, wherein the SRS configuration message enables the O-RU to perform an SRS-based channel estimation.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a pictorial depiction of functional splits in distributed architecture BSs, according to an embodiment of the disclosure;

FIG. 2 illustrates a functional split architecture for an extremely large massive multiple-in and multiple-out (X-MIMO) base station (BS), according to an embodiment of the disclosure;

FIG. 3 illustrates a functional block diagram of sounding reference signal (SRS) processing at an open radio access network (O-RAN) distributed unit (O-DU), according to an embodiment of the disclosure;

FIG. 4 illustrates a functional block diagram of an SRS processing at an O-RAN radio unit (O-RU), according to an embodiment of the disclosure;

FIG. 5 illustrates an O-RAN architecture for exchanging sounding reference signal (SRS) configuration parameters between an open radio access network (O-RAN) distributed unit (DU) (O-DU) and an O-RAN radio unit (O-RU), according to an embodiment of the disclosure;

FIG. 6 illustrates a block diagram of a system for exchanging SRS configuration parameters between an O-DU and an O-RU in an O-RAN, according to an embodiment of the disclosure; and

FIG. 7 illustrates a flow diagram depicting a method for exchanging SRS configuration parameters between an O-DU and an O-RU in the O-RAN, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It will be understood that the singular forms “a,” “an,” and “the” include plural referents unless the context clearly dictates otherwise. Thus, for example, reference to “a component surface” includes reference to one or more of such surfaces.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the disclosure. Some embodiments have been described for the purpose of explaining one or more of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in an embodiment of the disclosure, or may be found in more than one embodiment, or may be found in all embodiments of the disclosure, or may be found in no embodiments of the disclosure. Although one or more features and/or elements may be described herein in the context of only a single embodiment, or in the context of more than one embodiment of the disclosure, or in the context of all embodiments of the disclosure, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Hereinafter, it is understood that terms including “unit” or “module” at the end may refer to the unit for processing at least one function or operation and may be implemented in hardware, software, or a combination of hardware and software.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, coupled to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: only A, only B, only C, both A and B, both A and C, both B and C, all of A, B and C, or any variations thereof. As an additional example, the expression “at least one of a, b, or c” may indicate only a, only b, only c, both a and b, both a and c, both b and c, all of a, b, and c, or any variations thereof. Similarly, the term “set” means one or more. Accordingly, the set of items may be a single item or a collection of two or more items.

Unless otherwise defined, all terms, and especially any technical and/or scientific terms, used herein may be taken to have the same meaning as commonly understood by one having ordinary skill in the art.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. In addition, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits, such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports, such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, or the like, may be used herein to describe various elements, these elements should not be limited by these terms. These terms are generally only used to distinguish one element from another.

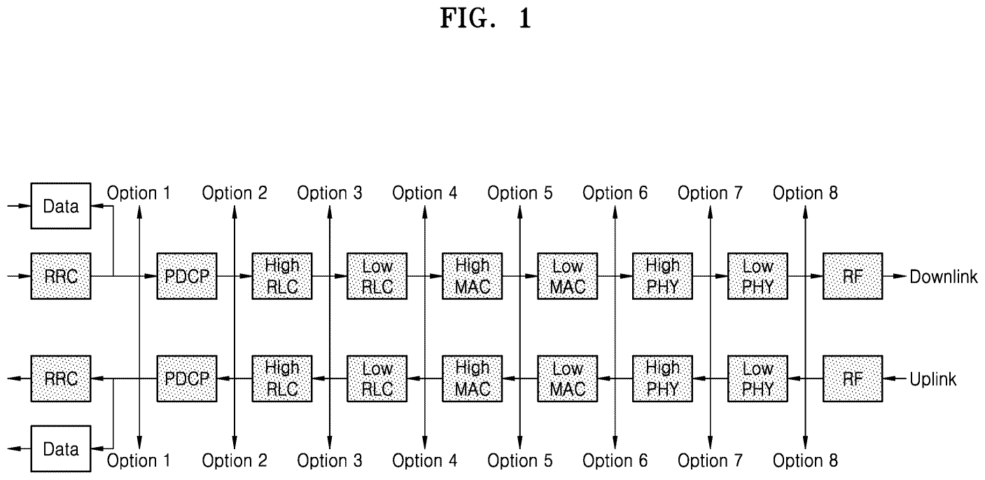

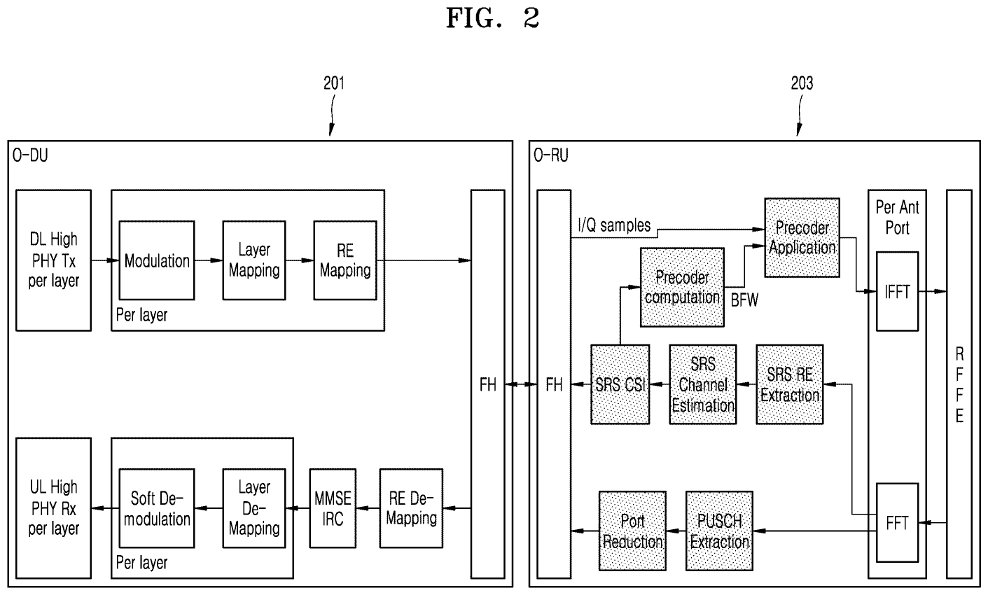

For the sake of clarity, the first digit of a reference numeral of each component of the disclosure is indicative of the Figure number, in which the corresponding component is shown. For example, reference numerals starting with digit “1” are shown at least in FIG. 1. Similarly, reference numerals starting with digit “2” are shown at least in FIG. 2.

Furthermore, the use of the terms “including” or “having” is not limiting. Any range described herein will be understood to include the endpoints and all values between the endpoints. Features of the disclosed embodiments may be combined, rearranged, omitted, or the like, within the scope of the disclosure to produce additional embodiments. Furthermore, certain features may sometimes be used to advantage without a corresponding use of other features.

An open radio access network (O-RAN) is a disaggregated approach for deploying mobile front-haul and mid-haul networks on cloud-native principles. Typically, a functional split in the O-RAN determines the amount of functions performed locally at an antenna site, also known as an O-RAN radio unit (O-RU). The functional split further determines the number of functions centralized at a high processing powered data center, also known as O-RAN distributed unit (O-DU), for optimizing a network architecture, performance, and efficiency. Further, the O-DU and the O-RU are connected via a Fronthaul (FH) interface.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates a pictorial depiction of functional splits in distributed architecture BSs, according to an embodiment of the disclosure.

Referring to FIG. 1, the 3^{rd} generation partnership project (3GPP), a standards organization for mobile telecommunications, has proposed eight functional split options (labeled 1 to 8), each with several sub-options.

Further, 3GPP also defines a 7.2X functional split architecture of the O-RAN. In the 7.2X functional split, the O-RU performs various technical processes, such as analog-to-digital conversion, time domain processing, cyclic prefix (CP) removal/addition, fast Fourier transform (FFT)/inverse fast Fourier transform (IFFT), combining/compression, or the like. Specifically, the O-RU includes various modules, such as a precoding module, an inphase/quadrature phase (IQ) compression module, a digital beamforming module, an IFFT and CP addition module, a digital to analog module, an analog beamforming module, or the like. Further, the O-DU performs channel estimation, equalization, and Layer 1 (L1) and Layer 2 (L2) processing. Specifically, the O-DU includes various modules, such as a scrambling module, a modulation module, a layer mapping module, a precoding module, a resource element (RE) mapping module, the IQ compression module, or the like. Most of the L1 processing in the 7.2x functional split architecture occurs in the O-DU, thereby simplifying processing at the O-RU. Further, the 7.2x functional split architecture defines two types of O-RU, category A and category B. The category A O-RU does not support precoding, while precoding occurs in the category B O-RU. Further, the control plane and user plane communication with the O-RU is controlled by the O-DU.

3GPP also defines extremely large massive multiple input multiple output (X-MIMO) technology. The X-MIMO is a technology where the number of antennas (NRX) at a base station (BS) is significantly large, typically in the order of thousands. In order to support the X-MIMO scenario, a new split is introduced in the O-RAN architecture where the O-RU has some additional functionalities, such as sounding reference signal (SRS) processing and port reduction.

FIG. 2 illustrates a functional split architecture of an X-MIMO base station (BS), according to an embodiment of the disclosure.

Referring to FIG. 2, in the SRS processing, an O-RU 203 processes the SRS by extracting the REs carrying the SRS signal from user equipment (UEs) to estimate a channel across the RE. The O-RU 203 also obtains channel state information (CSI) corresponding to each UE by processing the SRS. An estimated channel matrix is also used to derive the precoder matrix, which is applied to the downlink signal before its conversion to a time-domain signal. Further, the O-RU 203 receives the signal from NRx antennas at the BS, which is a large number (in order of 1000s) in the case of the X-MIMO, so the O-RU 203 cannot simply send data worth N_{RX} streams to an O-DU 201, since such transmission chokes the fronthaul (FH) link. Therefore, a new split introduced a port reduction module in the O-RU 203. The port reduction module combines the N_{RX} streams and sends only NL. (Number of Layers) streams to the O-DU 201, thereby maintaining a fronthaul bandwidth limit.

Therefore, in a 7.2x functional split, a higher function split promotes simpler functionalities at the O-RU 203, thereby facilitating a simple implementation. For harnessing the benefits of centralized processing, most of the processing is done at the O-DU 201. Hence, there is a high Front-Haul (FH) overhead because the O-RU 203 only performs basic analog and lower physical layer (PHY) processing on received signals. The majority of the processing is done at the O-DU 201, and hence, most of the received signals need to be sent from the O-RU 203 to the O-DU 201 for complete processing. This results in a higher amount of data being transmitted over the front-haul link, leading to increased overhead.

Another issue that arises is that the O-DU 201 calculates beamforming weights based on channel conditions and sends the calculated weights to the O-RU 203. The O-RU 203 then uses these weights to perform precoding which prepares the signal for transmission. This process requires the transmission of additional data (e.g., the beamforming weights) from the O-DU 201 to the O-RU 203 over the front-haul link. In general, the more streams that need to be transmitted, the larger the fronthaul throughput needs to be in order to accommodate the data. This is because each stream adds to the overall data volume that needs to be transmitted over the link.

However, there is a new split that introduces the SRS signal processing and port reduction at the O-RU 203, making the O-RU 203 comparatively computationally intensive. Due to the new functional split, there is lower front-haul throughput as the port reduced data is transferred to O-DU 201. Moreover, the need to transfer the beamforming weights for precoder/port reduction is no longer required.

Further, Table 1 highlights the trade-off between the existing ORAN 7.2x functional split with Category B O-RU and the functional split for X-MIMO systems.

TABLE 1

| 7.2x Functional Split | X-MIMO functional split |
|---|---|
| Simpler functionalities at O-RU | O-RU is comparatively |
| make it simple for implementation | computation intensive with |
| | additional features of SRS |
| | processing and port reduction |
| High fronthaul overhead | Lower fronthaul overhead |
| Sending beamforming weights | No need to transfer beamforming |
| from O-DU to O-RU for | weights for precoder/port reduction |
| performing precoding at O-RU | |

In 7.2x split architecture, the category B O-RU handles RF and time-domain processing before transmitting the frequency-domain signal to the O-DU, which completes the remaining L1 and L2 processing in the Uplink (UL). In the downlink (DL), the O-RU also performs DL precoding, utilizing precoder information provided by the O-DU. Further, in the X-MIMO functional split architecture, the O-RU has additional capabilities of SRS processing and port reduction in UL while performing the DL precoding in DL where the precoder/BF is computed at the O-RU itself.

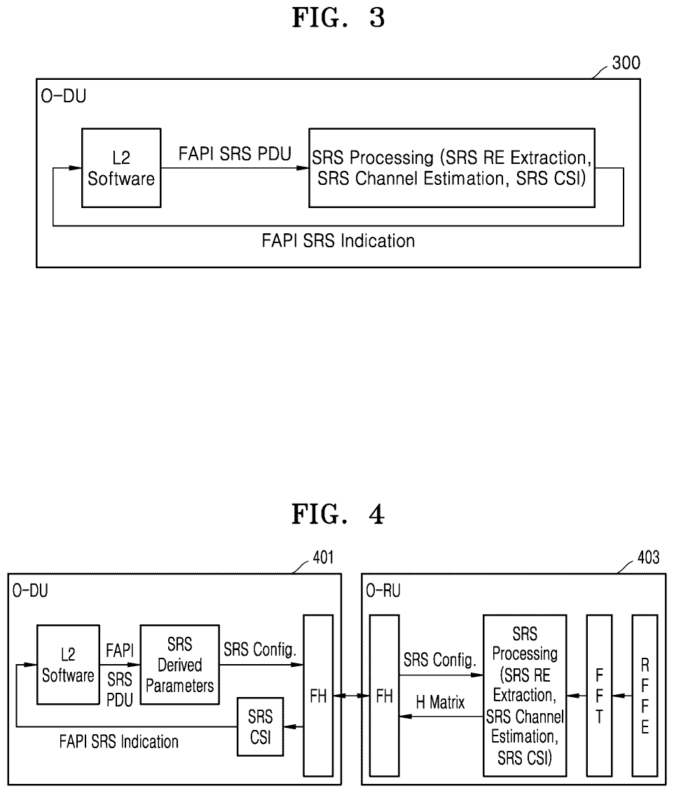

FIG. 3 illustrates a functional block diagram of the SRS processing at an O-DU, according to an embodiment of the disclosure. In the 7.2x split, the SRS processing occurs at an O-DU 300 with the help of Layer 2 (L2) messages received over a functional application programming interface (FAPI). The O-DU 300 receives a FAPI SRS packet data unit (PDU) which contains parameters related to SRS generation and resource element (RE) mapping.

Using the information elements from the SRS PDU, the O-DU 300 obtains the time and frequency domain mapping of the SRS signal in the resource grid. Further, the O-DU 300 uses the information obtained from the SRS PDU and the resource grid mapping to compute the transmitted SRS signal. Further, the O-DU 300 estimates the channel characteristics across the SRS resources by correlating the computed transmitted SRS signal with the received SRS signal. This estimation is used to generate the CSI report which provides feedback to the L2 via another FAPI message called SRS Indication.

Further, the SRS processing is implemented at the O-DU 300 conventionally. However, for X-MIMO-like scenarios where the number of digital ports and antenna arrays is huge, significant FH bandwidth is required for just control signalling as opposed to that for data signalling. For example, as shown in Table 2, FH throughput for Digital BF accounts for 150 Gbps while that for user data is only 44 Gbps:

TABLE 2

| Number of layers | 4 | 16 | 64 |
|---|---|---|---|
| QAM | 256 | 256 | 256 |
| Modulation bits | 8 | 8 | 8 |
| IQ Width in bits | 32 | 32 | 32 |
| Com IQ Width in bits | 18 | 18 | 18 |
| Num PRB | 273 | 273 | 273 |
| Num Symbols | 14 | 14 | 14 |
| TTI Duration (in ms) | 0.5 | 0.5 | 0.5 |
| Total RE per second | 366912000 | 1467648000 | 5870592000 |
| FH Throughput without | 10.9348297 | 43.7393188 | 174.957275 |
| compression (Gbps) | | | |
| FH Throughput with BFP | 6.15084171 | 24.6033669 | 98.4134674 |
| (Gbps) | | | |
| FH Throughput with MC | 2.73370743 | 10.9348297 | 43.7393188 |
| (Gbps) | | | |
| Actual C-Plane Overhead | 0.02297759 | 0.02297759 | 0.09191036 |
| (Gbps) | | | |
| Actual U-Plane (Data + | 2.76041031 | 11.0416412 | 44.1665649 |
| Header) (Gbps) | | | |
| Total FH Data Throughput | 2.7833879 | 11.0646188 | 44.2584753 |
| (Gbps) | | | |
| User Throughput (Gbps) | 2.56968498 | 10.2787399 | 41.1149597 |
| Number of Digital Ports | 32 | 64 | 256 |
| Number of Subbands | 137 | 137 | 137 |
| FH Throughput for Digital BF | 0.58794022 | 4.70352173 | 75.2563477 |
| (Gbps) | | | |
| Number of Subbands | 273 | 273 | 273 |
| FH Throughput for Digital BF | 1.1715889 | 9.37271118 | 149.963379 |
| (Gbps) | | | |

Therefore, the SRS processing feature is moved to O-RU in the X-MIMO functional split architecture to reduce the FH consumption solely by the control signalling. Hence, there is no need to transfer digital beamforming from O-DU to O-RU, thus eliminating the significant throughput requirement for control signalling.

FIG. 4 illustrates a functional block diagram of an SRS processing at an O-RAN radio unit (O-RU), according to an embodiment of the disclosure.

Referring to FIG. 4, the SRS processing feature is moved from an O-DU 401 to an O-RU 403. The O-RU 403 now handles tasks related to SRS estimation and feeding back SRS channel state information (CSI). To enable communication between the O-DU 401 and O-RU 403 for SRS processing, equivalent control plane (C-Plane) messages are needed. These messages, similar to FAPI messages, include parameters required for the SRS signal generation and RE mapping. The FAPI message contains numerous parameters used by the O-DU 401 for the SRS signal generation and the RE mapping.

Further, instead of sending the complete FAPI SRS PDU, the O-DU 401 can derive some parameters using information elements from the FAPI message and tables from section 6.4.1.4 of 3GPP specification document 38.211 [1] (3GPP technical specification group radio access network, NR physical channels and modulation (Release 17)). This eliminates excessive computation as well as the storage of tables at the O-RU 403. By deriving the minimum required set of parameters at the O-DU 401 and sending only those to the O-RU 403, the system achieves more efficient SRS processing.

The SRS is used for channel sounding in uplink. Further, the parameters for SRS in 5G NR are shown in Table 3.

TABLE 3

| Parameter | Description |
|---|---|
| N^{SRS}_{symb} | length of SRS in the time domain |
| m_{SRS,b} | number of PRBs (38.211[1], Table 6.4.1.4.3-1) |
| K_{TC} | transmission comb |
| k₀ | start position of SRS in the frequency domain |
| l₀ | start position of SRS in symbols |
| l_{offset} | defines the start of SRS in the time domain |
| C_{SRS} | defines the SRS bandwidth configuration |
| | (38.211[1], Table 6.4.1.4.3-1) |
| B_{SRS} | defines the SRS bandwidth configuration |
| | (38.211[1]. Table 6.4.1.4.3-1) |
| Bₕₒₚ | defines the hopping for SRS (38.211[1], Table |
| | 6.4.1.4.3-1) |
| r^{(pi)} (k′, l′) = | cyclic shifted low PAPR sequence |
| r^{αi,δ}_{u,v} (k′) | |
| αᵢ | cyclic shift applied to Low PAPR sequence for |
| | port I |
| δ | defines the length of the SRS sequence |
| u | group hopping number |
| v | sequence number |
| K_{TC}k′ + K^{(pi)}0 | frequency domain location |
| l′ + l₀ | time domain location |
| β_{SRS} | power control factor for SRS |
| N_{αp} | number of SRS antenna port |
| Pᵢ | port number |
| n_{shift} | defines the frequency domain shift |

Further, some of the examples of SRS generic parameters are bandwidth part size (Bwpsize), bandwidth part start RE (Bwpstart), sub-carrier spacing (Scs), and cyclic prefix (normal/extended) (CP). Some other FAPI version specific parameters are also present in the FAPI SRS PDU, which are derived from one or more parameters of Table 3.

Further, there are FAPI messages related to SRS instructing the O-DU to perform SRS-based channel estimation and report the CSI to the L2. However, with the SRS processing feature moved to the O-RU, the message equivalent for FAPI messages needs to be transferred between the O-DU and the O-RU to aid the SRS processing at the O-RU. To facilitate this transfer, there is a need for C-Plane messages that can carry the SRS configuration information from the O-DU to the O-RU. The SRS configuration information includes all the derived parameters obtained at the O-DU. Additionally, another C-Plane message is required from the O-RU to the O-DU, consisting of the estimated channel matrix corresponding to each UE. In the existing architecture, there are no C-Plane message types or extensions that specifically cater to the flow of SRS-related information between the O-DU and O-RU.

Hence, the pre-defined messages in the O-RAN specification do not cater to the specific scenario of additional capabilities at the O-RU which are present in the X-MIMO functional split architecture. Accordingly, there is a need for a solution to overcome the above-mentioned and other related problems in the X-MIMO functional split architecture without excessively utilizing the fronthaul bandwidth.

The disclosure provides techniques for an O-DU to share a minimal number of SRS parameters over a fronthaul link with an O-RU such that the O-DU does not consume too much of fronthaul bandwidth in sharing the SRS-related information. In addition, in an embodiment of the disclosure, the O-DU does not offload too much processing of intermediate parameters to the O-RU increasing its implementation complexity. In an embodiment of the disclosure, the disclosure also discloses C-Plane messages that consist of a minimal number of derived parameters that are needed at the O-RU to generate the SRS sequence and map the SRS sequence to the REs, in order to carry out the SRS channel estimation efficiently.

Embodiments of the disclosure will be described below with reference to the accompanying drawings.

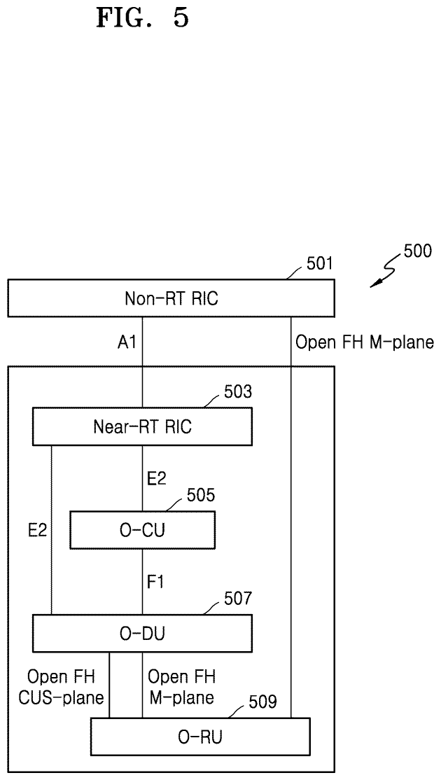

FIG. 5 illustrates an O-RAN architecture for exchanging sounding reference signal (SRS) configuration parameters between an open radio access network (O-RAN) distributed unit (DU) (O-DU) and an O-RAN radio unit (O-RU), according to an embodiment of the disclosure.

Referring to FIG. 5, open radio access network (O-RAN) architecture 500, driven by O-RAN Alliance is based on the disaggregation of the traditional RAN systems into O-RAN Central Unit (O-CU) 505, O-RAN distributed unit (O-DU) 507, and O-RAN radio unit (O-RU) 509 components. O-RAN 500 may include a near real-time RAN intelligent controller (near-RT RIC) 503 that enables near-real-time control and optimization of O-RAN elements and resources via fine-grained data collection and actions over an E2 interface. O-RAN 500 may include a non-real time RIC (Non-RT RIC) 501 that enables non-real-time control and optimization of RAN elements and resources, AI/machine learning (ML) workflow including model training and updates, and policy-based guidance of applications/features in the Near-RT RIC 503. O-RAN has introduced new interfaces and architectures relying on openness and interoperability that support enabling programmable data-driven control and intelligence in network deployments. For example, the Non-RT RIC 501 may be connected to the Near-RT RIC 503 using an AI interface. The Non-RT RIC 501 may be connected to the O-RU 509 using an open FH management (M)-plane interface. The Near-RT RIC 503 may be connected to the O-CU 505 and the O-DU 507 using the E2 interface. The O-CU 505 may be connected to the O-DU 507 using an F1 interface. The O-DU 507 may be connected to the O-RU 509 using an Open FH M-plane interface and an Open FH control user synchronization (CUS)-plane interface. In an embodiment of the disclosure, the disclosure provides techniques for sharing SRS configuration between the O-DU 507 and the O-RU 509. Accordingly, in an embodiment of the disclosure, the disclosed techniques may be implemented in the O-DU 507.

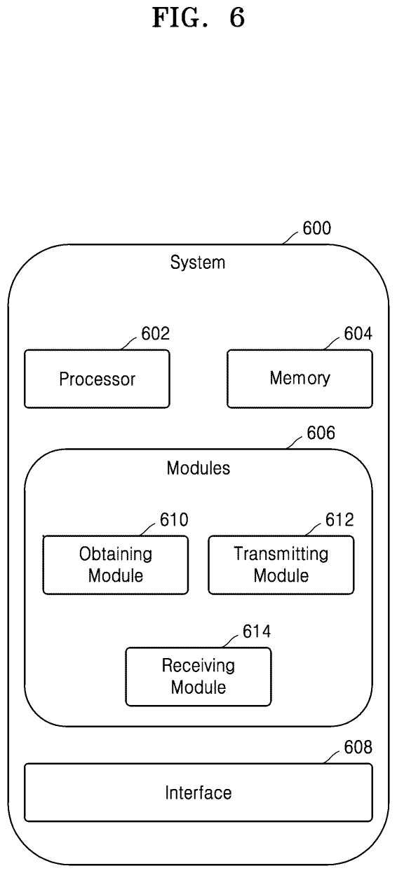

FIG. 6 illustrates a block diagram of a system for exchanging SRS configuration parameters between an O-DU and an O-RU in an O-RAN according to an embodiment of the disclosure.

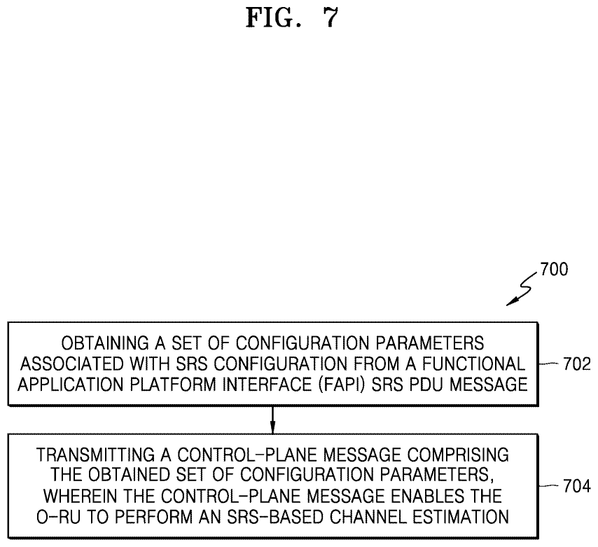

FIG. 7 illustrates a flow chart depicting a method 700 for exchanging SRS configuration parameters between an O-DU and an O-RU in an O-RAN according to an embodiment of the disclosure. For the sake of brevity, the description of FIGS. 5, 6, and 7 are explained in conjunction with each other.

Referring to FIG. 6, a system 600 may include but is not limited to, at least one processor 602 (herein referred to as a processor), memory 604, modules 606, and an interface 608. The memory 604, the modules 606, and the interface 608 may be coupled to the processor 602. In an embodiment of the disclosure, the system 600 may be a part of the O-DU 507. In an embodiment of the disclosure, the system 600 may be coupled to the O-DU 507. In an embodiment of the disclosure, the system 600 may be placed on any component connected to the O-DU 507.

The processor 602 can be a single processing unit or several units, all of which could include multiple computing units. The processor 602 may be implemented as one or more microprocessors, microcomputers, microcontrollers, digital signal processors, central processing units, state machines, logic circuitries, and/or any device that manipulates signals based on operational instructions. Among other capabilities, the processor 602 is configured to fetch and execute computer-readable instructions and data stored in the memory 604.

The memory 604 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, the memory 604 may include an operating system for performing one or more tasks of the system 600, as performed by a generic operating system in the communications domain.

The modules 606 amongst other things, include routines, programs, objects, components, data structures, or the like, which perform particular tasks or implement data types. The modules 606 may also be implemented as, signal processor(s), state machine(s), logic circuitries, and/or any other device or component that manipulates signals based on operational instructions.

Further, the modules 606 can be implemented in hardware, instructions executed by a processing unit, or by a combination thereof. The processing unit can comprise a computer, a processor, such as the processor 602, a state machine, a logic array, or any other suitable wearable device capable of processing instructions. The processing unit can be a general-purpose processor which executes instructions to cause the general-purpose processor to perform the required tasks or, the processing unit can be dedicated to performing the required functions. In an embodiment of the disclosure, the modules 606 may be machine-readable instructions (software) that, when executed by a processor/processing unit, perform any of the described functionalities.

In an embodiment of the disclosure, the modules 606 may include a set of instructions that may be executed to cause the system 600 to perform any one or more of the methods disclosed herein. The modules 606 may be configured to perform the steps of the disclosure using the data stored in the memory 604 to facilitate exchanging SRS configuration parameters between the O-DU 507 and the O-RU 509 in the O-RAN 500, as discussed throughout this disclosure. In an embodiment of the disclosure, each of the modules 606 may be hardware units that may be outside the memory 604.

In an embodiment of the disclosure, the modules 606 may include an obtaining module 610, a transmitting module 612, and a receiving module 614. The modules 606 and their working are further explained in the following paragraphs.

The various modules 610-614 may be in communication with each other. In an embodiment of the disclosure, the various modules 610-614 may be a part of the processor 602. In an embodiment of the disclosure, the processor 602 may be configured to perform the functions of modules 610-614.

At least one of the modules 610-614 may be implemented through an artificial intelligence (AI) model. A function associated with AI may be performed through the non-volatile memory, the volatile memory, and the processor 602. Accordingly, the processor 602 may include one or a plurality of processors. At this time, one or a plurality of processors may be a general purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through the calculation of a previous layer and an operation of a plurality of weights. Examples of neural networks include but are not limited to, convolutional neural networks (CNNs), deep neural networks (DNNs), recurrent neural networks (RNNs), restricted Boltzmann machines (RBMs), deep belief networks (DBNs), bidirectional recurrent deep neural network (BRDNNs), generative adversarial networks (GANs), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, a method for exchanging SRS configuration parameters between the O-DU 507 and the O-RU 509 in the O-RAN 500 may use an artificial intelligence model to recommend/execute the plurality of instructions by using sensor data. The processor 602 may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation.

The interface 608 may be configured to provide network connectivity and enable communication with paired devices, such as the system 600. The network connectivity may be provided via a wireless connection or a wired connection. For example, the network connectivity may be provided via cellular technology, such as third-generation (3G), fourth-generation (4G), fifth-generation (5G), sixth-generation (6G), pre-6G, 6G, or any other wireless communication technology, such as Bluetooth.

Referring back to FIG. 7, at operation 702, the method 700 may include obtaining a set of SRS configuration parameters associated with SRS configuration from a functional application platform interface (FAPI) SRS PDU message. In an embodiment of the disclosure, the set of SRS configuration parameters may include but is not limited to, transmission comb offset (K_{TC}), a sequence number (v), a group number (u), a maximum cyclic shift value (n_{CS}^{max}), a number of resource blocks (RBs) for SRS (m_{SRS,b}), a number of SRS symbols (N_{SRS}^{Symb}), an SRS start time index (l₀), a cyclic shift per port (n_{CS}ⁱ), and a frequency offset in resource element (RE) mapping (k₀^{(pi)}). Table 4 below illustrates definitions of the various configuration parameters:

TABLE 4

| IE | Size | Type | Description |
|---|---|---|---|
| srsConf | 1b | Binary | Defines if additional parameters are present: 0 −> absent, |
| | | | 1 −> present |
| K_{TC} | 2b | Unsigned int | Transmission Comb Offset : 0 −> 2, 1 −> 4, 2 −> 8 |
| v | 1b | Binary | Sequence number: 0−> no sequence hopping, 1 −> |
| | | | sequence hopping |
| u | 5b | Unsigned int | Group number: {0, 1, . . . , 29} |
| n^{max}_{CS} | 2b | Unsigned int | Maximum cyclic shift value: 0 −> 8, 1 −> 12, 2 −> 6 |
| m_{SRS,b} | 9b | Unsigned int | Number of RBs for SRS: can take values basis table in |
| | | | 38.211 |
| N^{Symb}_{SRS} | 4b | Unsigned int | Number of SRS symbols: {1, 2, 4, 8, 10, 12, 14} |
| l₀ | 4b | Unsigned int | SRS start time index : {0, 1, . . . , 13} |
| nⁱ_{CS} | 4b | Unsigned int | Cyclic shift per port (or ueld) : {0, 1, . . . , 11} |
| k^{(pi)}₀ | 12b | Unsigned int | Frequency offset in RE mapping |

In an embodiment of the disclosure, the set of SRS configuration parameters may be a reduced set of SRS parameters as compared to the complete FAPI SRS PDU message. The set of SRS configuration parameters are used for SRS processing without significantly increasing the computational complexity at the O-RU 509 as no complex computations and storage of tables are required at the O-RU 509.

In an embodiment of the disclosure, the obtaining module 610 may obtain the set of SRS configuration of parameters from the FAPI SRS PDU message. In particular, the obtaining module 610 may obtain a plurality of SRS parameters required for the SRS signal generation, a plurality of time parameters required for time domain mapping, and a plurality of frequency parameters required for frequency mapping from the FAPI SRS PDU message. The plurality of SRS parameters may include but are not limited to cyclic shift per port (αᵢ), SRS sequence ID (n_{ID}^{SRS}), length of SRS sequence (δ), u, v, wherein:
αᵢ may be obtained using n_{SRS}^{CS,max} (38.211, Table 6.4.1.4.2-1 of 3GPP technical specification (TS)), Nₐₚ^{SRS} and n_{CS}ⁱ. Nₐₚ^{SRS} is present in the FAPI SRS PDU message, whereas n_{CS}ⁱ maybe obtained as:

$${n}_{CS}^{i} = ( {n}_{SRS}^{CS} + \frac{{n}_{CS}^{max} ( {p}_{i} - 1000 )}{{N}_{ap}^{SRS}} ) , \\ where pi = 1000 + \{ 0 , 1 , … , {N}_{ap}^{SRS} - 1 \} \qquad Equation 1$$

δ=log₂ K_{TC}. K_{TC} is present in the FAPI SRS PDU message;
u, v may be obtained using groupOrSequenceHopping and n_{ID}^{SRS}, as discussed below:
If groupOrSequenceHopping=‘neither’ then u=0, v=0
If groupOrSequenceHopping=‘groupHopping’ then v=0, and

$$u = ( {f}_{gh} ( {n}_{s , f}^{μ} , {l}^{′} ) + {n}_{ID}^{SRS} ) mod 30 \qquad Equation 2$$

If groupOrSequenceHopping=‘sequenceHopping’ then u=0 and

$$v = \{ \begin{matrix}c ( {n}_{s , f}^{μ} {N}_{slot}^{sym} + {l}_{0} + {l}^{′} ) & when {M}_{SC , b}^{SRS} \geq 6 {N}_{sC}^{RB} \\ 0 & otherwise\end{matrix} \qquad Equation 3$$

n_{ID}^{SRS} is present in the FAPI SRS PDU message.

Using the plurality of SRS parameters, a zadoff-chu (ZC) based low peak to average power ratio (PAPR) sequence for the SRS may be generated at the O-RU 509 for channel estimation.

In an embodiment of the disclosure, the plurality of time parameters may include but are not limited to: l₀, N_{sym}^{SRS}, wherein:
N_{symb}^{SRS}, and l₀ are present in the FAPI SRS PDU message, and l′ may be determined using the equation:

$${l}^{′} = 0 , 1 , … , {N}_{symb}^{SRS} - 1 \qquad Equation 4$$

l′, (l₀+l′) helps in providing the time location/symbol location for the SRS resource at the O-RU 509. l′ defines an orthogonal frequency-division multiplexing (OFDM) symbol number.

In an embodiment of the disclosure, the plurality of frequency parameters may include but are not limited to: K_{TC}, k₀^{(pi)}, M_{sc,b}^{SRS}, wherein:
K_{TC} is present in the FAPI SRS PDU message;
k₀^{(pi)} may be obtained using k̅₀̅^̅{̅(̅p̅i̅)̅}̅, n_{offset}^{FH} as defined in section 6.4.1.4.3 of 38.211 using the parameters provided in FAPI PDU;

$${M}_{sc , b}^{SRS} = \frac{{m}_{SRS , b} {N}_{SC}^{RB}}{{K}_{TC}} \qquad Equation 5$$

where m_{SRS,b} may be obtained using a row corresponding to C_{SRS} in Table 6.4.1.4.3-1 given in 38.211 [1] of the 3GPP TS, and C_{SRS} is present in the FAPI SRS PDU message;

Using M_{sc,b}^{SRS}, k′ may be determined as

$${k}^{′} = 0 , 1 , … , {M}_{sc , b}^{SRS} - 1 \qquad Equation 6$$

(K_{TC}k′+k₀^{(pi)}) gives the frequency location/frequency domain mapping for SRS resources that may be obtained at O-RU 509.

Accordingly, the obtaining module 610 may obtain the set of SRS configuration parameters using the tables and the expressions provided in section 6.4.1.4 of 38.211 [1]. Thus, the O-DU 507 may eliminate the requirement of storing tables at the O-RU 509 and excessive computation at the O-RU 509. Table 5 shows a summary of the set of SRS configuration parameters:

TABLE 5

| SRS Config Parameters | FAPI or derived Parameters |
|---|---|
| n^{max}_{CS} | Derived |
| nⁱ_{CS} | Derived |
| u | Derived |
| v | Derived |
| l₀ | FAPI |
| N^{SRS}_{symb} | FAPI |
| K_{TC} | FAPI |
| k^{(pi)}₀ | Derived |
| m_{SRS,b} | Derived |

Referring to FIG. 7, at operation 704, the method 700 may include transmitting, to the O-RU 509, an SRS configuration message comprising the obtained set of SRS configuration parameters. The SRS configuration message may enable the O-RU 509 to perform an SRS-based channel estimation. In an embodiment of the disclosure, the SRS configuration message corresponds to a section extension (SE X) message comprising a bit indicating the presence of the set of SRS configuration parameters associated with the SRS. Table 6 illustrates an SE X message defining the size and type of the various configuration parameters (represented as IE):

TABLE 6

| IE | Size | Type | Description |
|---|---|---|---|
| srsConf | 1b | Binary | Defines if additional parameters are present: 0 −> absent, |
| | | | 1 −> present |
| K_{TC} | 2b | Unsigned int | Transmission Comb Offset: 0 −> 2, 1 −> 4, 2 −> 8 |
| v | 1b | Binary | Sequence number: 0 −> no sequence hopping, 1 −> |
| | | | sequence hopping |
| u | 5b | Unsigned int | Group number: {0,1, ... ,29} |
| n^{max}_{CS} | 2b | Unsigned int | Maximum cyclic shift value: 0 −> 8, 1 −> 12, 2 −> 6 |
| m_{SRS,b} | 9b | Unsigned int | Number of RBs for SRS: can take values basis table in |
| | | | 38.211 |
| N^{Symb}_{SRS} | 4b | Unsigned int | Number of SRS symbols: {1, 2, 4, 8, 10, 12, 14} |
| l₀ | 4b | Unsigned int | SRS start time index: {0, 1, . . . ,13} |
| nⁱ_{CS} | 4b | Unsigned int | Cyclic shift per port (or ueld): {0, 1, . . . , 11} |
| k^{(pi)}₀ | 12b | Unsigned int | Frequency offset in RE mapping |
| ko | | | |

The parameters included in the SE X message aid the O-RU 509 in generating the SRS signal and identifying the RE mapping. The SE X message may define the SRS configuration on a per ueId basis (or layer-wise). In an embodiment of the disclosure, the SE X message may inherently indicate the request from the O-DU 507 for receiving the SRS-based channel estimation that is extracted at the O-RU 509 based on the set of SRS configuration parameters. Accordingly, the SE X message may include a request for receiving a channel estimation matrix from the O-RU 509. In an embodiment of the disclosure, the O-RU 509 may provide feedback of the channel information to the O-DU 507 using the existing section type (ST) 6 message. In such a scenario, the ST6 message is transferred from the O-RU 509 to the O-DU 507 as opposed to the other direction. Table 7 illustrates an SE X message:

TABLE 7

| | | | | | | | | # of | |
|---|---|---|---|---|---|---|---|---|---|
| 0(msb) | 1 | 2 | 3 | 4 | 5 | 6 | 7(lsb) | bytes | Octet |

| ef | extType = X | | | | 1 | N |
|---|---|---|---|---|---|---|
| extLen = variable | | | | | 1 | N + 1 |
| srsConf | K_{TC}[1:0] | n_{CS}^{max} [1:0] | v | u [4:3] | 1 | N + 2 |

| | | | | |
|---|---|---|---|---|
| u [2:0] | n_{cs}ⁱ [3:0] for 1^{st} ueId | Zero Pad | 1 | N + 3 |

| k₀^{(pi)} [11:4] | | 1 | N + 4 |
|---|---|---|---|
| k₀^{(pi)} [3:0] | reserved | 1 | N + 5 |

| | | | | | | |
|---|---|---|---|---|---|---|
| srsConf | K_{TC}[1:0] | n_{CS}^{max} [1:0] | v | u [4:3] | 1 | N + 6 |

| | | | | |
|---|---|---|---|---|
| u [2:0] | n_{CS}ⁱ [3:0] for 2^{nd} ueId | Zero Pad | 1 | N + 7 |

| k₀^{(pi)} [11:4] | | 1 | N + 8 |
|---|---|---|---|
| k₀^{(pi)} [3:0] | reserved | 1 | N + 9 |

| 3^{rd} ueId | | | | | |
|---|---|---|---|---|---|
| 4^{th} ueId | | | | | |
| . . . | | | | | |
| srsConf | K_{TC}[1:0] | n_{CS}^{max} [1:0] | v | u [4:3] | 1 |

| | | | |
|---|---|---|---|
| u [2:0] | n_{CS}ⁱ [3:0] for last ueId | Zero Pad | 1 |

| k₀^{(pi)} [11:4] | | 1 |
|---|---|---|
| k₀^{(pi)} [3:0] | reserved | 1 |

| | |
|---|---|
| zero padding to ensure 4-byte boundary | var |

In an embodiment of the disclosure, the transmitting module 612 may transmit the SE X message along with one of a SE10 message and a ST5 message. For example, the transmitting module 612 may transmit the SE X message following one of the SE10 message and the ST5 message. In an embodiment of the disclosure, the transmitting module 612 may transmit the SRS configuration message along with the SE10 message and ST5 message when a user equipment (UE) connected with the O-RAN architecture 500 supports a multi-layer transmission. In an embodiment of the disclosure, the transmitting module 612 may transmit the SRS configuration message along with the SE5 message when the UE connected with the O-RAN architecture 500 supports a single-layer transmission. Table 8 illustrates an SE X message with the ST5 and SE10 messages, in accordance with an embodiment of the disclosure:

TABLE 8
Section Type 5: UE scheduling information conveyance

| | | | | | | | | # of | |
|---|---|---|---|---|---|---|---|---|---|
| 0(msb) | 1 | 2 | 3 | 4 | 5 | 6 | 7(lsb) | bytes | |
| ecoriVersion = 00001b | | | | ecpriReserved = 000b | | | ecpriConcatenation = 0 | 1 | Octet 1 |
| ecpriMessage = 0x02 (for C-plane data) | | | | | | | | 1 | Octet 2 |
| ecpriPayload (the eCPRI payload size in byte, excluding padding bytes) | | | | | | | | 2 | Octet 3 |
| ecpriRtcid (the representative-tx-eaxc-id1) (SRS port id) | | | | | | | | 2 | Octet 5 |
| ecpriSeqid (see Table 8.1.2.1-2) | | | | | | | | 2 | Octet 7 |
| dataDirection = 1 | payloadVersion | | | filterIndex | | | | 1 | Octet 9 |
| (for DL) | | | | | | | | | |

| frameId | | 1 | Octet 10 |
|---|---|---|---|
| subframeId | slotId | 1 | Octet 11 |

| | | | |
|---|---|---|---|
| slotId | startSymbolId = l₀ for SRS | 1 | Octet 12 |

| numberOfsections | | | | 1 | Octet 13 |
|---|---|---|---|---|---|
| sectionType = 5 | | | | 1 | Octet 14 |
| udCompHdr | | | | 1 | Octet 15 |
| reserved | | | | 1 | Octet 16 |
| sectionId[11:4] | | | | 1 | Octet 17 |
| sectionId[3:0] | rb | symInc | startPrbc[9:8] | 1 | Octet 18 |

| startPrbc[7:0] = 0 | | 1 | Octet 19 |
|---|---|---|---|
| numPrbc = m_{SRS, b} for SRS | | 1 | Octet 20 |
| reMask[11:4] | | 1 | Octet 21 |
| reMask[3:0] = 0xFFF | numSymbol = N_{SRS}^{symb} for SRS | 1 | Octet 22 |

| ef = 1 | 1^{st} port ueId[14:8] | 1 | Octet 23 |
|---|---|---|---|
| 1^{st} port ueId[7:0] (corresponding to the representative eAxC ID) | | 1 | Octet 24 |
| ef = 1 | extType = 0x0A | 1 | Octet 25 |

| extLen = 0x21 (33 words) | | 1 | Octet 26 |
|---|---|---|---|
| beamGroupType = 10b | numPortc = 63 | 1 | Octet 27 |

| reserved | 2^{nd} port ueId[14:8] | | | | 1 | Octet 28 |
|---|---|---|---|---|---|---|
| 2^{nd} port ueId[7:0] | | | | | 1 | Octet 29 |
| reserved | 3^{rd} port ueId[14:8] | | | | 1 | Octet 30 |
| 3^{rd} port ueId[7:0] | | | | | 1 | Octet 31 |
| . . . | | | | | | |
| reserved | 64^{th} port ueId[14:8] | | | | 1 | Octet 152 |
| 64^{th} port ueId[7:0] | | | | | 1 | Octet 153 |
| Zero padding | | | | | 1 | Octet 154 |
| Zero padding | | | | | 1 | Octet 155 |
| Zero padding | | | | | 1 | Octet 156 |
| ef = 1 | extType = X (for the 1^{st} ueId) | | | | 1 | Octet 157 |
| extLen = var | | | | | 1 | Octet 158 |
| srsConf | K_{TC}[1:0] | n_{CS}^{max} [1:0] | v | u [4:3] | 1 | Octet 159 |

| | | | | |
|---|---|---|---|---|
| u [2:0] | n_{CS}ⁱ [3:0] for 1st ueId | Zero Pad | 1 | Octet 160 |

| k₀^{(pi)} [11:4] | | 1 | Octet 161 |
|---|---|---|---|
| k₀^{(pi)} [3:0] | reserved | 1 | Octet 162 |

| . . . | | | | | | |
|---|---|---|---|---|---|---|
| ef = 0 | extType = (for the 64^{th} ueId) | | | | 1 | Octet 535 |
| extLen = var | | | | | 1 | Octet 536 |
| srsConf | K_{TC}[1:0] | n_{CS}^{max} [1:0] | v | u [4:3] | 1 | Octet 537 |

| | | | | |
|---|---|---|---|---|
| u [2:0] | n_{CS}ⁱ [3:0] for last ueId | Zero Pad | 1 | Octet 538 |

| k₀^{(pi)} [11:4] | | 1 | Octet 539 |
|---|---|---|---|
| k₀^{(pi)} [3:0] | reserved | 1 | Octet 540 |

| | |
|---|---|
| zero padding to ensure 4-byte boundary | var |

In Table 8, Octets 1-7 may represent transport Header with representative eAxC_ID. Octets 9-16 may represent the application header with the SRS start symbol l₀. Octets 17-24 may represent the ST5 Section Header with the number of SRS symbols N_{SRS}^{Symb} and the number of SRS PRBS m_{SRS,b}. Octets 25-156 may represent SE10 with multi-layer information with 64 ueIds. Octets 157-540 may represent SE X message for SRS configuration of each layer. It should be noted that octets 25-156 are present in the SE10 message only. The ST5 message may be similar to the SE10 message when a single-layer scenario is used but without the octets 25-534.

In an embodiment of the disclosure, the transmitting module 612 may transmit the SRS configuration message as a section type 6 (ST6) message. The ST6 may include at least one of a channel information per layer for SRS configuration and a flag indicating the presence of the set of SRS configuration parameters associated with the SRS configuration. Table 9 illustrates an SRS configuration message as the ST6 message, in accordance with an embodiment of the disclosure:

TABLE 9

| | | | | | | | | # of | |
|---|---|---|---|---|---|---|---|---|---|
| 0(msb) | 1 | 2 | 3 | 4 | 5 | 6 | 7(lsb) | bytes | Octet |

| Transport header, see clause 5.1.3 | | | 8 | Octet 1 |
|---|---|---|---|---|
| dataDirection | payloadVersion | filterIndex | 1 | Octet 9 |

| frameId | | 1 | Octet 10 |
|---|---|---|---|
| subframeId | slotId | 1 | Octet 11 |

| | | | |
|---|---|---|---|
| slotId | startSymbolId = l₀ | 1 | Octet 12 |

| numberOfSections | | 1 | Octet 13 |
|---|---|---|---|
| SectionType = 6 | | 1 | Octet 14 |
| numberOfUEs | | | Octet 15 |
| ciCompHdr | | 1 | Octet 16 |
| ef | ueId [14:8] 1^{st} ueId | 1 | Octet 17 |

| ueId[7:0] | | | | 1 | Octet 18 |
|---|---|---|---|---|---|
| Regularization Factor | | | | 2 | Octet 19 |
| Reserved | rb | symInc | startPrbc[9:8] | | Octet 21 |

| startPrbc[7:0] | | | | | | Octet 22 |
|---|---|---|---|---|---|---|
| numPrbc = m_{SRS, b} | | | | | | Octet 23 |
| srsConf | srsCi | K_{TC}[1:0] | n_{CS}^{max} [1:0] | u [4:3] | 1 | Octet 24 |

| | | | | |
|---|---|---|---|---|
| u [2:0] | v | N_{SRS}^{symb} = [3:0] | 1 | Octet 25 |

| | | | |
|---|---|---|---|
| n_{CS}ⁱ [3:0] | k₀^{(pi)} [11:8] | 1 | Octet 26 |

| k₀^{(pi)} [7:0] | | 1 | Octet 27 |
|---|---|---|---|
| 3^{rd} ueId | | | |
| 4^{th} ueId | | | |
| . . . | | | |
| ef | ueId [14:8] 1st ueId | 1 | Octet N |

| ueId[7:0] | | | | 1 | N + 1 |
|---|---|---|---|---|---|
| Regularization Factor | | | | 2 | N + 2 |
| Reserved | rb | symInc | startPrbc[9:8] | | N + 4 |

| startPrbc[7:0] | | | | | | N + 5 |
|---|---|---|---|---|---|---|
| numPrbc = m_{SRS, b} | | | | | | N + 6 |
| srsConf | srsCi | K_{TC}[1:0] | n_{CS}^{max} [1:0] | u [4:3] | 1 | N + 7 |

| | | | | |
|---|---|---|---|---|
| u [2:0] | v | N_{SRS}^{symb} [3:0] | 1 | N + 8 |

| | | | |
|---|---|---|---|
| n_{CS}ⁱ [3:0] | k₀^{(pi)} [11:8] | 1 | N + 9 |

| | | |
|---|---|---|
| k₀^{(pi)} [7:0] | 1 | N + 10 |
| <padding with zeros to the next 4-byte boundary> may not be present (NOTE) | var | |
| Section Extensions as indicated by “ef” | var | |

NOTE:
“may not be present” depends on O-RU boolean flag “st6-4byte-alignment-required”.
NOTE:
The remainder of N divided by 4 is 1 if 4-byte alignment is to be used.

As shown in Table 9, the existing ST6 may be modified to carry the set of SRS configuration parameters from the O-DU 507 to the O-RU 509 using a flag, e.g., “‘srsCi’”. Accordingly, ‘srsCi’ may indicate the presence of the set of SRS configuration parameters. If the flag is disabled (e.g. srsCi=0) then the ST6 may carry the SRS configuration message per ueId from the O-DU 507 to the O-RU 509. However, if the flag is enabled (e.g. srsCi=1) then the ST6 may carry channel information per ueId from the O-RU 509 to O-DU 507. Accordingly, the receiving module 614 may receive the channel estimation matrix from the O-RU 509 in response to transmitting the SRS configuration message. Accordingly, when srsCi=1, the ST6 message may be transferred from the O-RU 509 to the O-DU 507. In an embodiment of the disclosure, the ST6 with the SRS configuration message may have a smaller size when transferred from the O-DU 507 to the O-RU 509.

Accordingly, the disclosure may provide techniques for the transfer of SRS configuration elements between the O-DU 507 and the O-RU 509 with a reduced set of SRS configuration parameters as compared to the complete FAPI SRS PDU. Such transfer may result in SRS processing without significantly increasing the computational complexity at the O-RU 509. Further, the disclosure may disclose SRS configuration messages for transmitting the set of SRS configuration parameters in order to process the incoming SRS signal. The contents of the SRS configuration message may be defined so that the SRS configuration message does not generate significant overhead at the fronthaul and at the same time does not introduce severe computational complexity at the O-RU 509.

Accordingly, the disclosure may provide various advantages. For example, the disclosed techniques may reduce the fronthaul bandwidth required for sharing the SRS configuration information between the O-DU 507 and the O-RU 509. The disclosed techniques may provide higher data rates and throughput. The disclosed techniques may provide reduced computational complexity at the O-RU 509 for carrying out additional SRS processing features using the set of SRS configuration parameters received from the O-DU 507. Further, the disclosed techniques may help in eliminating the storage of large tables at the O-RU 509 for generating the set of SRS configuration parameters.

In an embodiment, a method performed by an open radio access network (O-RAN) distributed unit (DU) (O-DU) in a wireless communication system is provided.

In an embodiment, the method, wherein the SRS configuration message may correspond to a section extension (SE X) message comprising a bit indicating presence of the set of SRS configuration parameters.

In an embodiment, the method, wherein the transmitting of the SRS configuration message may include transmitting the SRS configuration message along with one of a section extension 10 (SE10) message and a section type (ST) 5 message.

In an embodiment, the method, wherein the transmitting of the SRS configuration message may include transmitting the SRS configuration message along with a ST5 message and a section extension10 (SE10) message in case that a user equipment (UE) connected with an O-RAN supports a multi-layer transmission.

In an embodiment, the method, wherein the SRS configuration message may include a request for receiving a channel estimation matrix from the O-RU. The method, wherein the channel estimation matrix may be determined at the O-RU based on the set of SRS configuration parameters.

In an embodiment, the method, wherein the transmitting of the SRS configuration message may include transmitting the SRS configuration message as a section type 6 (ST6) message including at least one of a channel information per layer for SRS configuration or a flag indicating presence of the set of SRS configuration parameters.

In an embodiment, the method, wherein the set of SRS configuration parameters may include at least one of a transmission comb offset (K_{TC}), a sequence number (v), a group number (u), a maximum cyclic shift value (n_{CS}^{max}), a number of resource blocks (RBs) for SRS (m_{SRS,b}), a number of SRS symbols (N_{SRS}^{Symb}), an SRS start time index (l₀), a cyclic shift per port (n_{CS}ⁱ), or a frequency offset in resource element (RE) mapping (k₀^{(pi)}).

In an embodiment, the method may include receiving a channel estimation matrix from the O-RU in response to transmitting the SRS configuration message.

In an embodiment, an open radio access network (O-RAN) distributed unit (DU) (O-DU) is provided. The O-DU may include at least one processor.

In an embodiment, the O-DU, wherein the SRS configuration message may correspond to a section extension (SE X) message comprising a bit indicating presence of the set of SRS configuration parameters.

In an embodiment, the O-DU, wherein the at least one processor may be further configured to transmit the SRS configuration message along with one of a section extension 10 (SE10) message and a section type5 (ST5) message.

In an embodiment, the O-DU, wherein the at least one processor may be further configured to transmit the SRS configuration message along with a section extension10 (SE10) message in case that a user equipment (UE) connected with an O-RAN supports a multi-layer transmission.

In an embodiment, the O-DU, wherein the SRS configuration message may include a request for receiving a channel estimation matrix from the O-RU. The O-DU, wherein the channel estimation matrix may be determined at the O-RU based on the set of SRS configuration parameters.

In an embodiment, the O-DU, wherein the at least one processor may be further configured to transmit the SRS configuration message as a section type 6 (ST6) message including at least one of a channel information per layer for SRS configuration or a flag indicating presence of the set of SRS configuration parameters.

In an embodiment, the O-DU, wherein the set of SRS configuration parameters may include at least one of a transmission comb offset (K_{TC}), a sequence number (v), a group number (u), a maximum cyclic shift value (n_{CS}^{max}), a number of resource blocks (RBs) for SRS (m_{SRS,b}), a number of SRS symbols (N_{SRS}^{Symb}), an SRS start time index (l₀), a cyclic shift per port (n_{CS}ⁱ), or a frequency offset in resource element (RE) mapping (k₀^{(pi)}).

In an embodiment, the O-DU, wherein the at least one processor may be further configured to receive a channel estimation matrix from the O-RU in response to transmitting the SRS configuration message.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an open radio access network (O-RAN) distributed unit (DU) (O-DU) in a wireless communication system, the method comprising:
obtaining a set of sounding reference signal (SRS) configuration parameters from a functional application platform interface (FAPI) SRS PDU message; and
transmitting, to an O-RAN radio unit (O-RU), an SRS configuration message comprising the obtained set of SRS configuration parameters, wherein the SRS configuration message enables the O-RU to perform an SRS-based channel estimation.

2. The method of claim 1, wherein the SRS configuration message corresponds to a section extension (SE X) message comprising a bit indicating presence of the set of SRS configuration parameters.

3. The method of claim 2, wherein the transmitting of the SRS configuration message comprises:
transmitting the SRS configuration message along with one of a section extension10 (SE10) message and a section type (ST) 5 message.

4. The method of claim 2, wherein the transmitting of the SRS configuration message comprises:
transmitting the SRS configuration message along with a ST5 message and a section extension10 (SE10) message in case that a user equipment (UE) connected with an O-RAN supports a multi-layer transmission.

5. The method of claim 2,
wherein the SRS configuration message includes a request for receiving a channel estimation matrix from the O-RU, and
wherein the channel estimation matrix is determined at the O-RU based on the set of SRS configuration parameters.

6. The method of claim 1, wherein the transmitting of the SRS configuration message comprises:
transmitting the SRS configuration message as a section type 6 (ST6) message including at least one of a channel information per layer for SRS configuration or a flag indicating presence of the set of SRS configuration parameters.

7. The method of claim 1, wherein the set of SRS configuration parameters includes at least one of a transmission comb offset (KTC), a sequence number (v), a group number (u), a maximum cyclic shift value (n_{CS}^{max}), a number of resource blocks (RBs) for SRS (m_{SRS,b}), a number of SRS symbols (N_{SRS}^{Symb}), an SRS start time index (l₀), a cyclic shift per port (n_{CS}ⁱ), or a frequency offset in resource element (RE) mapping (k₀^{(pi)}).

8. The method of claim 1, further comprising:
receiving a channel estimation matrix from the O-RU in response to transmitting the SRS configuration message.

9. An open radio access network (O-RAN) distributed unit (DU) (O-DU) in a wireless communication system, the O-DU comprising:
at least one processor configured to:
obtain a set of sounding reference signal (SRS) configuration parameters from a functional application platform interface (FAPI) SRS PDU message, and
transmit, to an O-RAN radio unit (O-RU), an SRS configuration message comprising the obtained set of SRS configuration parameters, wherein the SRS configuration message enables the O-RU to perform an SRS-based channel estimation.

10. The O-DU of claim 9, wherein the SRS configuration message corresponds to a section extension (SE X) message comprising a bit indicating presence of the set of SRS configuration parameters.

11. The O-DU of claim 10, wherein the at least one processor is further configured to transmit the SRS configuration message along with one of a section extension10 (SE10) message and a section type5 (ST5) message.

12. The O-DU of claim 10, wherein the at least one processor is further configured to transmit the SRS configuration message along with a section extension 10 (SE10) message in case that a user equipment (UE) connected with an O-RAN supports a multi-layer transmission.

13. The O-DU of claim 10,
wherein the SRS configuration message includes a request for receiving a channel estimation matrix from the O-RU, and
wherein the channel estimation matrix is determined at the O-RU based on the set of SRS configuration parameters.

14. The O-DU of claim 9, wherein the at least one processor is further configured to transmit the SRS configuration message as a section type 6 (ST6) message including at least one of a channel information per layer for SRS configuration or a flag indicating presence of the set of SRS configuration parameters.

15. The O-DU of claim 9, wherein the set of SRS configuration parameters includes at least one of a transmission comb offset (KTC), a sequence number (v), a group number (u), a maximum cyclic shift value (n_{CS}^{max}), a number of resource blocks (RBs) for SRS (m_{SRS,b}), a number of SRS symbols (N_{SRS}^{Symb}), an SRS start time index (l₀), a cyclic shift per port (n_{CS}ⁱ), or a frequency offset in resource element (RE) mapping (k₀^{(pi)}).

16. The O-DU of claim 9, wherein the at least one processor is further configured to receive a channel estimation matrix from the O-RU in response to transmitting the SRS configuration message.
